(19) United States
(12) Patent Application Publication
(10) Pub. No.: US 2016/0006059 A1
(43) Pub. Date: Jan. 7, 2016

(54) DRIVING CONTROL METHOD AND SYSTEM OF FUEL CELL SYSTEM

(71) Applicants: HYUNDAI MOTOR COMPANY, Seoul (KR); Kia Motors Corporation, Seoul (KR)

(72) Inventors: Sang Uk Kwon, Suwon (KR); Soon Il Jeon, Yongin (KR); Ja Hoo Koo, Yongin (KR)

(21) Appl. No.: 14/556,705

(22) Filed: Dec. 1, 2014

(30) Foreign Application Priority Data
Jul. 2, 2014 (KR) 10-2014-0082646

(51) Int. Cl. H01M 8/04

(52) U.S. Cl. CPC H01M 8/04291; H01M 8/04335; H01M 8/04589; H01M 8/04522; H01M 8/0441; H01M 8/04649; H01M 8/04559; H01M 8/04731; H01M 8/04723

(57) ABSTRACT

A driving control system and method of a fuel cell system are provided. The driving control method includes determining, by a controller, when a fuel cell stack is in a water shortage, based on an oversupply of air to the fuel cell stack or a deterioration of the fuel cell stack. A diagnostic level is then assigned to the fuel cell system and at least one recovery driving mode that corresponds to the assigned diagnostic level is performed.

### CROSS REFERENCE TO RELATED APPLICATION

The present application claims priority of Korean Patent Application Number 10-2014-0082646 filed on Jul. 2, 2014, the entire contents of which application are incorporated herein for all purposes by this reference.

### BACKGROUND OF THE INVENTION

1. Field of the Invention

The present invention relates, generally, to a driving control method and system of a fuel cell system and, more particularly, to a fuel cell stack status-based, variable-recovery modality driving control method.

2. Description of the Related Art

A fuel cell system applicable to a hydrogen fuel cell vehicle, a type of eco-friendly vehicle, is composed of a fuel cell stack configured to generate electric power from an electrochemical reaction of reactant gas; a hydrogen supplying system configured to supply hydrogen as fuel to a fuel cell stack; an air supplying system configured to supply gas including oxygen as oxidant in electrochemical reactions; and a heat and water management system configured to manage water and to maintain an optimal fuel cell stack temperature for driving by emitting heat, which is a by-product of the electrochemical reaction.

In such a vehicular fuel cell system, when the fuel cell is used as a sole power source for a vehicle it undertakes all loads of the vehicle and, and thus the vehicle shows poor performance in an operation range where the fuel cell decreases in efficiency. Additionally, in the event of a sudden heavy power load being placed upon the vehicle, the vehicle performance may decrease due to the output power of the fuel cell decreasing rapidly and the driving motor may not be provided with sufficient electric power. It is well known that a fuel cell may not cope with rapid load variation due to the use of a chemical reaction to generate electricity.

Further, since a fuel cell has unidirectional output, energy introduced from a driving motor upon braking a vehicle may not be recovered, leading to a decrease in the efficiency of a vehicle system. As a solution to these problems, in addition to a fuel cell as main power source, an energy storage device such as a rechargeable high voltage battery or a super-capacitor (supercap) may be used as an auxiliary power source to power a driving motor and high voltage-requiring parts.

Meanwhile, hydrogen crossover is a phenomenon in which hydrogen remaining in an anode directly crosses an electrolyte membrane without generating electricity, and reacts with oxygen at a cathode. To reduce a hydrogen crossover rate, an anode pressure should be decreased in a low power region while an anode pressure should be increased in a high power region. A hydrogen crossover rate increases with an increase in anode pressure (e.g., hydrogen pressure). Since hydrogen crossover has unfavorable effects on fuel-efficiency and durability of a fuel cell, it is necessary to properly regulate anode pressure. A hydrogen purge valve is used in the related art to assure stack performance by emitting impurities and condensed water; and an anode outlet is connected to a water trap, the anode outlet emitting condensed water through a valve when the quantity of condensed water reaches a predetermined level.

To increase fuel-efficiency, as needed, during driving of a vehicle (Fuel Cell Stop/Fuel Cell Restart process), an idle stop and go system for temporarily stopping electricity generation of a fuel cell in a fuel cell hybrid vehicle (e.g., ON/OFF control process of a fuel cell) has been used. In the stopping and restarting electricity generation of a fuel cell during driving, dry-out of a fuel cell stack by air inflow, and reacceleration and fuel-efficiency of a vehicle are all controlled.

A system of the related art discloses a decrease of air supply to a fuel cell stack by air diversion through a bypass to prevent driving of a fuel cell at near open circuit voltage in a low power region, together with forced charging of a battery or the use of an auxiliary load. Another developed related art relates to a method of charging a battery by a forced voltage decrease of a fuel cell stack according to the amount of battery charge when the fuel cell stack is driven at substantially high temperatures. Further, another related art relates to a control method of a fuel cell hybrid system by stopping electricity generation of a fuel cell in a low power region and using the fuel cell only under a predetermined voltage when electricity is generated, for the purpose of fuel efficiency.

### SUMMARY

Accordingly, the present invention provides a driving control method of a fuel cell system in which a recovery driving mode is selected according to a status of a fuel cell stack.

A driving control method of a fuel cell system according to one exemplary embodiment of the present invention may include: determining when a fuel cell stack is in water shortage, based on an oversupply of air to the fuel cell stack or deterioration of the fuel cell stack; assigning a diagnostic level to the fuel cell system according to the determination; and performing at least one recovery driving mode that corresponds to the assigned diagnostic level.

The assigning process may include classifying a first status as a first diagnostic level, the first status being a status in which oversupply of air to the fuel cell stack is predicted due to a breakdown of the fuel cell system. The assigning may also include classifying a second status as a second diagnostic level, the second status being a status in which the fuel cell stack is predicted to be in a water shortage due to oversupply of air to the fuel cell stack.

The second status may be determined based on either a change in oversupply of air to the fuel cell stack to output current consumption of the fuel cell stack or a change of residual water in a cathode calculated from an estimated value of relative humidity in the cathode of the fuel cell stack. The second status may be a status in which a value calculated from oversupply of air, which is a difference between an amount of air required for output current consumption of the fuel cell stack and an amount of air being supplied to the fuel cell stack, and a driving temperature of the fuel cell stack is greater than a first reference value.

In addition, the second status may be a status in which a value calculated from a ratio of an amount of air supplied to the fuel cell stack to an amount of air required for output current consumption of the fuel cell stack, and a driving temperature of the fuel cell stack is greater than a first reference value. The estimated value of relative humidity in the cathode of the fuel cell stack may be obtained based on temperatures in cathode inlet and outlet of the fuel cell stack, an amount of air flow in an inlet of the fuel cell stack, and an amount of current generated in the fuel cell stack. The change of residual water may be calculated based on amount of water vapor flow in the cathode outlet when the relative humidity in the cathode outlet is the estimated value and when the relative humidity in the cathode outlet is in a range of about 90% to 110%.

The amount of water vapor flow in the cathode outlet may be calculated by a water vapor pressure in the cathode outlet, an air pressure in the cathode outlet based on an amount of air flow in an inlet of the fuel cell stack, and an amount of air flow in the inlet of the fuel cell stack. The process of assigning a diagnostic level may include assigning a third diagnostic level to the fuel cell system when deterioration of the fuel cell stack proceeds to a third status due to water shortage, as diagnosed with regard to current and voltage, impedance or current interruption of the fuel cell in the determination process.

The recovery driving mode may include a recovery driving mode for forcibly cooling the fuel cell stack by adjusting temperatures in the coolant inlet and outlet of the fuel cell stack, a recovery driving mode for relieving a condition of ingress into idle stop of the fuel cell system, a recovery driving mode for decreasing a voltage of a main bus terminal connected to an output terminal of the fuel cell stack, a recovery driving mode for reducing an amount of air inflow, and a recovery driving mode for driving the fuel cell stack in a minimum stoichiometry ratio (SR).

The recovery driving mode for forcibly cooling the fuel cell stack may be operated by setting target temperatures in the coolant inlet and outlet to be a lower value than a reference temperature. The recovery driving mode for forcibly cooling the fuel cell stack may be operated as temperatures in the coolant inlet and outlet are set to be higher by a predetermined offset than an actual temperature. The recovery driving process may be operated by varying the set reference temperature and the offset based on the assigned diagnostic level. The condition for ingress into idle stop is such that a fuel cell vehicle is imparted with a load less than a predetermined reference value and has a state of charge (SOC) of a battery greater than a predetermined state of charge; and the recovery driving mode for relieving a condition for ingress into Idle Stop is to increase the predetermined reference value and to decrease the predetermined state of charge.

The fuel cell stack may be operated in a recovery driving mode in which the predetermined reference value is increased and the predetermined state of charge is decreased based on the designated diagnostic level. When the fuel cell stack is operated in the recovery driving mode for decreasing a voltage of the main bus terminal connected to an output terminal of the fuel cell stack, a controller may be configured to determine whether it may be possible to charge the battery before proceeding with the recovery driving; and wherein the fuel cell stack may be operated in the recovery driving mode for decreasing a voltage of the main bus terminal, it is to decrease an upper limit of a driving voltage of the main bus terminal whereby an output power of the fuel cell stack may be prevented from being less than a predetermined output power.

The fuel cell stack may be operated in the recovery driving mode for decreasing a voltage of the main bus terminal connected to the output terminal of the fuel cell stack based on the designated diagnostic level, even during regenerative braking. When a state of charge (SOC) of the battery is greater than a predetermined SOC in the process of determining whether it may be possible to charge the battery before performing the recovery driving, the fuel cell stack may be operated to drive a high voltage heater connected to the output terminal of the fuel cell stack.

When the fuel cell stack is operated in the recovery driving mode for decreasing a voltage of the main bus terminal connected to the output terminal of the fuel cell stack, an upper voltage limit of the main bus terminal connected to the output terminal of the fuel cell stack may be decreased based on the designated diagnostic level. When the fuel cell stack is operated in a recovery driving mode for decreases an amount of air inflow, the amount of air inflow may be decreased based on the designated diagnostic level.

The recovery driving mode intended to drive the fuel cell stack in a minimum stoichiometry ratio (SR) is to decrease a control area of stoichiometry ratio based on relative humidity in the cathode of the fuel cell stack estimated from temperatures in the cathode inlet and outlet of the fuel cell stack, the amount of air flow in the inlet of the fuel cell stack, and the generated current of the fuel cell stack. When the fuel cell stack is operated in a recovery driving mode at a minimum stoichiometry ratio (SR), the stoichiometry ratio controlling area may be decreased based on a designated diagnostic level. The fuel cell stack may be operated in one selected from among various driving modes based on the designated diagnostic level.

According to one exemplary embodiment of a driving control method of a fuel cell system, it may be possible to prevent a fuel cell stack from dry-out and to increase durability of a fuel cell stack through a recovery driving process in a dry-out status. Additionally, performance decrease due to problems within a fuel cell system or driving pattern of a fuel cell stack, may be minimized and initial driving performance may be maintained more consistently.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exemplary block diagram of a power net of a fuel cell system according to one exemplary embodiment of the present invention;

FIG. 2 is an exemplary view of criteria for an operation of a fuel cell system according to one exemplary embodiment of the present invention;

FIG. 3 is an exemplary view of an idle stop and restart process of a fuel cell system according to one exemplary embodiment of the present invention;

FIG. 4 is an exemplary view of an idle stop and restart process of a fuel cell system according to one exemplary embodiment of the present invention in terms of changes in voltage and current over time;

FIG. 5 is an exemplary table summarizing the detection of status by diagnostic level, together with causes of the status, used in a driving control method of a fuel cell system according to one exemplary embodiment of the present invention;

FIG. 6 is an exemplary schematic view illustrating a relative humidity estimation model in a driving control method of a fuel cell system according to one exemplary embodiment of the present invention;

FIGS. 7 to 10 are exemplary flow diagrams of a driving control method of a fuel cell system according to an exemplary embodiment of the present invention;

FIG. 11 is an exemplary view illustrating a forcible cooling recovery driving according to one exemplary embodiment of the present invention;

FIG. 12 is an exemplary table showing recovery driving modes in correspondence to statuses of a fuel cell stack according to one exemplary embodiment of the present invention;

FIG. 13 is an exemplary view schematically illustrating variable stoichiometry ratio control on an air supply according to one exemplary embodiment of the present invention; and

FIG. 14 shows exemplary graphs demonstrating the effect of an exemplary embodiment of the present invention in comparison with conventional techniques.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

It is understood that the exemplary processes may be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Specific structural or functional descriptions in the exemplary embodiments of the present invention disclosed in the specification or application are merely for description of the exemplary embodiments of the present invention, can be embodied in various forms and should not be construed as limited to the embodiments described in the specification or application. Specific exemplary embodiments are illustrated in the drawings and described in detail in the specification or application because the exemplary embodiments of the present invention may have various forms and modifications. It should be understood, however, that there is no intent to limit the exemplary embodiments of the present invention to the specific embodiments, but the intention is to cover all modifications, equivalents, and alternatives included to the scope of the present invention.

Although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Reference now should be made to the drawings, in which the same reference numerals are used throughout the different drawings to designate the same or similar components.

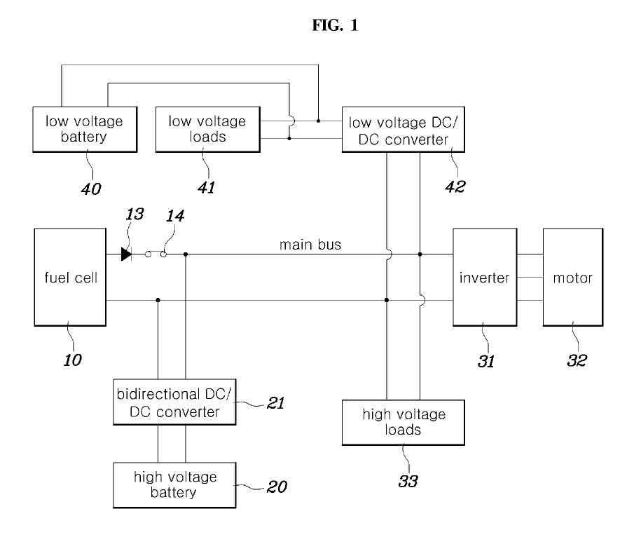

FIG. 1 is an exemplary block diagram of a power net of a fuel cell system according to one exemplary embodiment of the present invention. As illustrated in FIG. 1, a fuel cell-battery hybrid system for a vehicle may include: a fuel cell 10 as a main power source and a high voltage battery (main battery) 20 as an auxiliary power source, and are connected with each other in parallel via a main bus terminal 11; a bidirectional DC/DC converter (BHDC: Bidirectional High Voltage DC/DC Converter) 21 connected to the high voltage battery 20 and configured to adjust output power of the high voltage battery 20; an inverter 31 connected to the main bus terminal 11 on the output side of both the fuel cell 10 and the high voltage battery 20; a driving motor 32 connected to the inverter 31; a high voltage load 33 within the vehicle, exclusive of the inverter 31 and the driving motor 32; a low voltage battery (auxiliary battery) 40 and a low voltage load 41; and a low voltage DC/DC converter (LDC) 42, connected between the low voltage battery 40 and the main bus terminal 11, and configured to convert a high voltage to a low voltage.

Herein, both the fuel cell 10 as a main power source and the high voltage battery 20 as an auxiliary power source may be connected in parallel via the main bus terminal 11 to intra-system loads such as the inverter 31, the driving motor 32, etc. The bidirectional DC/DC converter 21 connected to the high voltage battery may be connected to the main bus terminal 11 at the output side of the fuel cell 10, and therefore it may be possible to adjust output power of both the fuel cell 10 and the high voltage battery 20 by adjusting a voltage of the bidirectional DC/DC converter 21 (e.g., an output voltage to the main bus terminal).

The fuel cell 10 may include at an output terminal thereof, a diode 13 to prevent back current and with a relay 14 to selectively connect the fuel cell 10 to the main bus terminal 11. The relay 14 may connect the fuel cell 10 to the main bus during the idle stop/restart process of the fuel cell system as well as during the driving of the vehicle under a normal operation of the fuel cell 10 and to disconnect the fuel cell 10 from the main bus upon the key-off of the vehicle (normal shutdown) or an emergency shutdown. Additionally, the inverter 31 connected via the main bus terminal 11 to an output side of both the fuel cell 10 and the high voltage battery 20 may be configured to actuate the driving motor 32 by phase shifting currents supplied from the fuel cell 10 and/or the high voltage battery 20.

The actuation of the driving motor 32 in this fuel cell system may be obtained by an FC driving mode in which the output power (current) of the fuel cell 10 is used, an EV driving mode in which the output power of the high voltage battery 20 is used, or an HEY driving mode in which the output power of the fuel cell 10 is used, with assistance from the high voltage battery 20. Particularly after the idle stop and restart in the fuel cell system, the EV driving mode, which is before the driving motor is driven by the output power of the fuel cell 10, is characterized in that the driving motor 32 and thus the vehicle may be driven by output power of the high voltage battery 20 since electricity generation of the fuel cell 10 is stopped.

In this EV driving mode, the relay 14 may be configured to turn on and electricity generation from the fuel cell 10 may be stopped while a voltage of the main bus terminal 11 is increased by boosting a voltage of the high voltage battery 20 through boost control of the bidirectional DC/DC converter 21 connected to the output terminal of the high voltage battery 20, whereby the output power of the high voltage battery 20 is used to operate loads in the vehicle, such as the inverter 31, the driving motor 32, etc. An air supply may be cut off at Idle Stop of the fuel cell system, and may resume at Restart. When the fuel system returns to a normal driving mode after Restart, the output power of a fuel cell 10 may be subject to follow-up control based on the load of a vehicle under the condition of normal air supply (load following control), and a boosting status of the bidirectional DC/DC converter 21 is released.

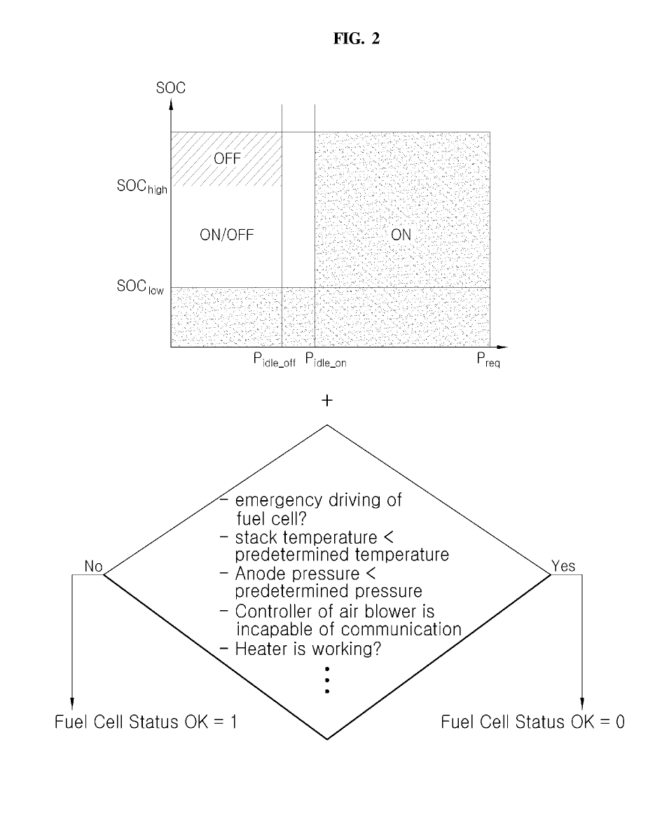

FIG. 2 is an exemplary view of criteria for an operation for a fuel cell system according to one exemplary embodiment of the present invention. A fuel cell controller (not shown) may be configured to execute Idle Stop, prohibition of Idle Stop, Restart, and the like by a process of detecting a vehicle status (left side) and a fuel cell status (right side) as illustrated in FIG. 2. Referring to FIGS. 1 and 2, a fuel cell controller may be configured to determine a fuel cell ON (e.g., electricity generation) and OFF (e.g., stopping electricity generation) condition based on vehicle status conditions including the load of the vehicle, and the SOC of the high voltage battery 20, which is an auxiliary power source, during the detection of a vehicle status. Additionally, the fuel cell controller may be configured to determine a condition for Idle Stop and prohibition of Idle Stop, and Restart, based on a condition for emergency driving of the fuel cell 10, a temperature of the fuel cell stack 10, an anode pressure of the fuel cell stack 10, a communication status between controllers, and whether the heater is operating, (e.g., these are all fuel cell status conditions).

When both a fuel cell OFF condition in a process of detecting a vehicle status, and an Idle Stop condition in a process of detecting a fuel cell status are satisfied simultaneously, the Idle Stop of a fuel cell may be conducted by the controller and when either a fuel cell ON condition in a process of detecting vehicle status or a Restart condition of the fuel cell in a process of detecting a fuel cell status is satisfied, the Restart of the fuel cell may be performed by the controller.

In the process of detecting a vehicle status, as illustrated in the left side plan of FIG. 2, a high load status in which a load of the vehicle is greater than a predetermined reference value (e.g., required output power of the fuel cell is greater than P_{idle}_{_{—}}ₒₙ) becomes a fuel cell ON condition. In addition, in case of a low load status where the vehicle has a load less than a predetermined reference value (e.g., required output power of the fuel cell is less than P_{idle}_{_{—}}_{off}), when SOC of the high voltage battery 20 is substantially greater than a predetermined upper limit (SOC_{high}), a fuel cell OFF condition, Idle Stop entrance condition, may be satisfied.

When the vehicle load is minimal, but with the SOC of a high voltage battery less than the lower limit (SOC_{low}), the fuel cell ON condition may be satisfied while the output power is maintained to be greater than the predetermined value (P_{idle}_{_{—}}ₒₙ) upon turning on the fuel cell to allow for the charging of the high voltage battery 20. Additionally, in consideration of the responsiveness of the system in the process of detecting a vehicle load, the fuel cell may be turned on upon a full or rapid acceleration greater than a predetermined level, and OFF upon regenerative braking to increasing the recuperation rate of regenerative braking.

Meanwhile, during the detecting of fuel cell status, as illustrated in a right side plan of FIG. 2, in a condition when the fuel cell is in a state of emergency driving, the stack may be maintained at a temperature less than a predetermined value to maintain electricity generation by the fuel cell when the stack has an anode pressure less than a predetermined value, the controller of air blower is incapable of communication, or the heater is operating (e.g., condition for prohibition of Idle Stop, condition for Start) (‘fuel cell status OK=0’ in FIG. 2). Under conditions other than the above, it may be determined by the controller that Idle Stop is possible (e.g., condition for Idle Stop) (‘fuel cell status OK=1’).

In the processes of detecting the vehicle status and fuel cell status, as illustrated in FIG. 2, when conditions of ‘fuel cell OFF and fuel cell status OK=1’ are satisfied, the fuel cell system undergoes ingress to Idle Stop. Further, when any of the conditions is not satisfied, the ingress of the fuel cell system to Idle Stop may be prohibited. For example, when a vehicle status condition, that is, a condition for vehicle load and SOC, although satisfactory for the fuel cell OFF condition, is determined as a condition for prohibition of Idle Stop (‘fuel cell status OK=0’), the ingress of the fuel cell system to Idle Stop may be prohibited. In addition, as illustrated in FIG. 2, when ‘fuel cell ON’ or ‘fuel cell status OK=0’ is determined, Idle Stop may be prohibited (in case of a normal driving) or a fuel cell is restarted (in case of Idle status). For example, in Idle Stop status of a fuel cell system, although vehicle status conditions (e.g., condition for vehicle load and SOC condition) are not satisfied with stack ON condition (‘fuel cell OFF condition’), when a condition for restarting electricity generation of a fuel cell (Start condition) (‘fuel cell status OK=0’) is satisfied, a fuel cell may be restarted.

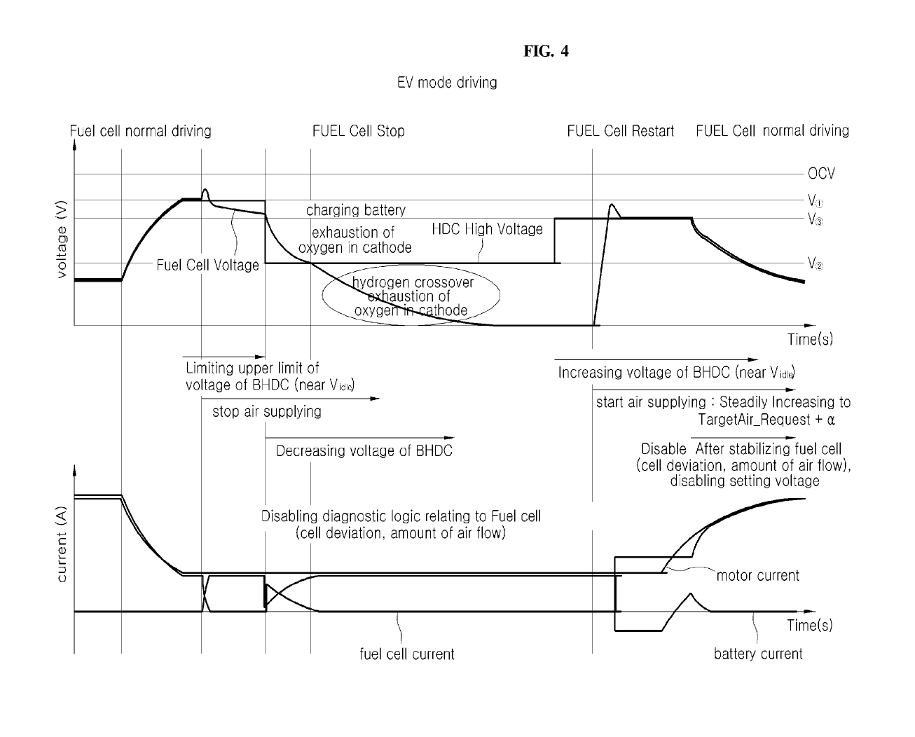

The fuel cell system may be inefficient in a low power region due to the constant operation of the accessory drive system. To avoid driving at this section, Pidle, which is an output power during the deterioration of efficiency, may be set as a condition for determining loads, while Vidle, a voltage that corresponds to Pidle, or a voltage near Vidle (V\textcircled{1} in FIG. 4) may be assigned as an upper limit for the voltage control of the bidirectional power converter, to limit the voltage adjusted by the bidirectional DC/DC converter 21 in the normal driving mode of the fuel cell system to the set upper limit for the voltage control, whereby a low power region of the fuel cell may be used restrictively.

In a normal driving mode of the fuel cell system in accordance with an exemplary embodiment of the present invention, that is, in the condition of performing a low following control of the fuel cell, as described above, the voltage adjusted by the bidirectional DC/DC converter 21 may be limited to an upper limit by assigning an upper limit of voltage control to the bidirectional DC/DC converter 21, while a low power region of the fuel cell may be used restrictively. When there is an upper limit for the voltage of the bidirectional DC/DC converter 21, the output power of the fuel cell may be maintained at a predetermined level or greater, with the associated restriction of the use of the fuel cell at a low power region. Further, when the output power of the fuel cell system is maintained at greater than Pidle, various problems may occur including battery overcharging in the low power region, the quantitative restriction of regenerative braking, etc. Hence, as described above, the fuel cell may be turned off (idle stop) upon regenerative braking or in the condition of a low output power and high SOC (fuel cell OFF condition in FIG. 2), to avoid the low efficiency section.

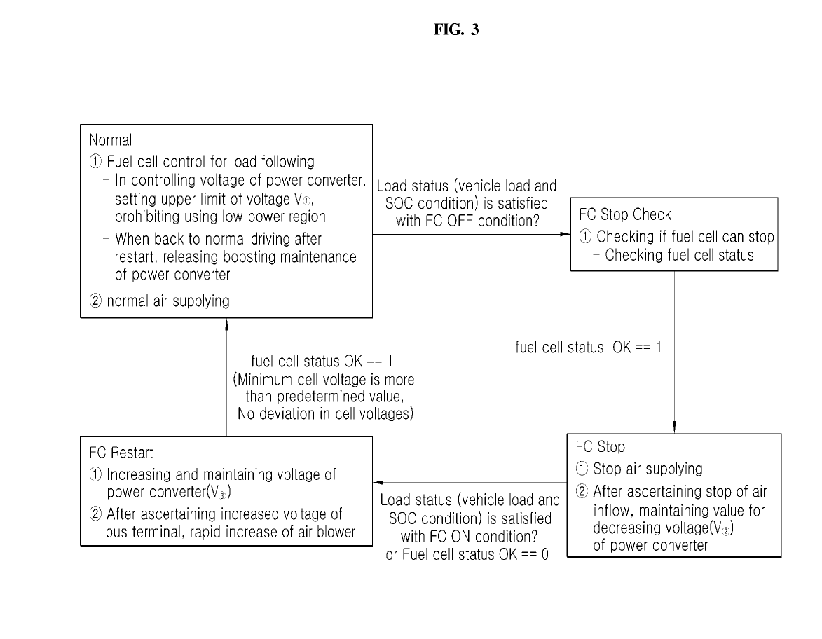

FIG. 3 is an exemplary view of an idle stop and restart process of a fuel cell system according to one exemplary embodiment of the present invention and FIG. 4 is an exemplary view illustrating an idle stop and restart process of a fuel cell system according to one exemplary embodiment of the present invention in terms of changes in voltage and current over time. Referring to FIGS. 3 and 4, a load following control in which the output power of the fuel cell is adjusted according to loads may be performed in a normal driving mode of the fuel cell system, and for the output power control of the fuel cell, the controller may be configured to adjust an output voltage of a main bus terminal of the bidirectional DC/DC converter 21 (hereinafter, abbreviated as a voltage of the bidirectional DC/DC converter 21).

Particularly, in the present invention, as an upper limit is set for the voltage control of the bidirectional DC/DC converter 21 (V\textcircled{1} in FIG. 4) in a normal driving mode of the fuel cell system, the voltage of the bidirectional DC/DC converter 21 adjusted based on loads during driving may be limited to the upper limit for the voltage control, thereby prohibiting the use of the fuel cell at a low power region. Similarly, in a normal driving mode, during driving for load following of a fuel cell, the output power of the fuel cell may be maintained at greater than a predetermined level by limiting the voltage of the bidirectional DC/DC converter 21 to an upper control limit set for the voltage control of the bidirectional DC/DC converter 21.

Subsequently, when the vehicle status conditions, that is, the vehicle loads and the SOC of the high voltage battery meets the fuel cell OFF condition in the process of detecting a vehicle status as illustrated in FIG. 2, the controller may be configured to determine whether the fuel cell status allows for Idle Stop of the fuel cell system. In particular, when a fuel cell status corresponds to a condition of prohibiting the Idle Stop of the fuel cell system (‘fuel cell status OK=0’ in FIG. 2) in the process of detecting the fuel cell status, although the vehicle status condition meets the fuel cell OFF condition, the fuel cell controller may be configured to prohibit the idle stop of the fuel cell system to maintain the fuel cell in a driving status, and release the upper limit of voltage by which the voltage of the bidirectional DC/DC converter 21 is limited to the set upper limit (V\textcircled{1}), and thus allow the fuel cell to be used in a low power region.

When the fuel cell 10 is not able to turn off in addition to the condition of being a low power region of the fuel cell 10 and a high SOC of the high voltage battery 20 (e.g., prohibition status of entering Idle Stop), the high voltage battery 20 may be overcharged when the output of the fuel cell continues to be maintained in a certain level by the upper limit for the voltage of the bidirectional DC/DC converter. In a process of detecting a fuel cell status, the idle stop of the fuel cell system may proceed with the fuel cell status being determined as an Idle Stop condition of the fuel cell system in the detecting process. In other words, the voltage of the fuel cell may be decreased below that of the main bus terminal by stopping air supply to the fuel cell 10 (e.g., turning off an air supplier such as air blower, etc.), whereby the output of the fuel cell (current output) to the main bus terminal may not be performed (Refer to a current of the fuel cell after stopping an air supply in FIG. 4)

Furthermore, after a predetermined period of time halting (stopping) the air supply, (or after ascertaining that there is no air supply with the aid of a flow meter), the voltage of the bidirectional DC/DC converter 21 may be reduced to a predetermined value (V\textcircled{2} in FIG. 2) to exhaust oxygen within the cathode. While the voltage of the bidirectional DC/DC converter 21 is reduced to and maintained at a predetermined value, the voltage of the main bus terminal, which becomes the output of the bidirectional DC/DC converter 21, may be decreased. Therefore, a current of the fuel cell may be output to the main bus terminal while oxygen in a cathode is exhausted, to forcibly charge the high voltage battery 20 with the output power of the fuel cell.

In other words, the high voltage battery 20 may be charged with the output current of the fuel cell 10 generated when oxygen in a cathode is exhausted until the voltage of the fuel cell 10 decreases under that of the bidirectional DC/DC converter 21 (e.g., a voltage of the main bus terminal), and residual oxygen within the cathode may be removed to a certain level by the forcibly charging of the high voltage battery 20.

In addition, when the voltage of the fuel cell 10 decreases to less than that of the bidirectional DC/DC converter with the exhaustion of oxygen within the cathode, the charging of the high voltage battery 20 may be terminated, and the oxygen within the cathode may be exhausted as hydrogen within the anode continually crosses over to the cathode through the electrolyte membrane. Thus, removal of the voltage of the fuel cell 10 completes ingress to Idle Stop (e.g., the voltage of the fuel cell is substantially removed). Accordingly, the output power of the fuel cell 10 generated upon the exhaustion of oxygen in the cathode may be used for charging the high voltage battery 20 through a voltage control by which the voltage of the bidirectional DC/DC converter 21 is decreased to a predetermined value (V\textcircled{2}) after air supply is stopped. In addition, the voltage of the fuel cell 10 may be decreased, thus obtaining advantageous effects in terms of both durability and fuel efficiency of the stack.

After the high voltage battery 20 is forcibly charged during the exhaustion of oxygen in the cathode of the fuel cell 10, when the voltage of the fuel cell 10 decreases again to less than that of the main bus terminal, that is, the voltage of the bidirectional DC/DC converter 21, no current may be output from the fuel cell 10 to perform the EV mode driving in which the driving motor is driven by the output power of the high voltage battery.

Referring to FIG. 4, it is illustrated that voltages of both the bidirectional DC/DC converter 21 and the fuel cell may be limited by the upper limit for voltage control (V\textcircled{1}) in the section before air supply starts to be stopped. Accordingly, a current of the fuel cell may be maintained at a particular level by adjusting the voltage to the upper limit. In addition, it is understood that EV mode driving may be performed by supplying a battery current to the inverter through MCU (Motor Control Unit) in the section extending from the termination of air supply to the restart of the fuel cell. In this regard, EV mode driving in which a voltage of the main bus terminal is maintained at a predetermined value (V\textcircled{2}) (e.g., a constant value or a variable value) through the voltage control of the bidirectional DC/DC converter 21 may be performed.

It may be necessary to optimally set a predetermined value (V\textcircled{2}) to which the voltage of the bidirectional DC/DC converter 21 is decreased after stopping the air supply, in terms of the efficiency of both the bidirectional DC/DC converter 21 and the driving motor 32. For the efficiency of the driving motor 32 the value (V\textcircled{2}) may be set to a substantially high value, and the EV mode driving may be operated by setting the value (V\textcircled{2}) at a substantially low value in terms of the efficiency of the bidirectional DC/DC converter. Hence, a proper value is required for the value (V\textcircled{2}). During EV mode driving, as described above, when a vehicle status condition is suitable for fuel cell “ON” or a fuel cell status condition is a condition (‘fuel cell status OK=0’ in FIG. 2), the fuel cell system may be restarted. In this regard, the voltage of the bidirectional DC/DC converter 21 may be increased and maintained at a predetermined value (V\textcircled{3} in FIG. 5) to prevent the fuel cell from excessively outputting to the main bus terminal.

When the vehicle is restarted at higher than the output power of the fuel cell, although a vehicle load condition is not satisfied (e.g., a low load status in which a vehicle load is less than a reference value, in other words, the required output power of a fuel cell is under Pidle_on), the voltage of the bidirectional DC/DC converter may be further increased and maintained near OCV (Open Circuit Voltage), that is, a maximum limit less than OCV. As in Idle Stop, when a voltage for restart, that is, a predetermined voltage to which the voltage of the bidirectional DC/DC converter 21 increases (V\textcircled{3}), is maintained at near Vidle in FIG. 2, when a vehicle load is under a reference value and the SOC of the high voltage battery 20 is substantially high, the output power of the fuel cell 10 may overcharge the high voltage battery 20.

After the main bus terminal has determined the predetermined value (V\textcircled{3}) with a voltmeter, a fuel cell controller may be configured to restart electricity generation of the fuel cell 10 and restart electricity generation by starting an air supply. At the start point of air supply, the voltage of the fuel cell 10 may be increased to that of the bidirectional DC/DC converter 21 (V\textcircled{3}) by increasing the number of revolutions of an air blower. In this context, the fuel cell 10 may be configured to output a substantially constant power that corresponds to the increased value (V\textcircled{3}) of the bidirectional DC/DC converter 21 in addition to increasing in voltage by air supply. Additionally, an air blower may be operated to supply a predetermined amount of air (α), plus a required amount of air based on current requirement to rapidly increase a voltage of a fuel cell 10 when restarting an air supply in a restarting process. So ‘a required amount+a predetermined amount’ of air may be supplied to a fuel cell.

After that, the status of the fuel cell may be continuously monitored and when a minimum cell voltage, deviation of cell voltages, an amount of air flow, etc. are stabilized, the restarting process may be terminated and the maintenance of a predetermined value for the voltage of the bidirectional DC/DC converter 21 may be stopped. Thereafter, in a normal driving mode, the fuel cell 10 may be operated to perform a normal load following control in a normal driving mode. In this regard, the voltage of the bidirectional DC/DC converter 21 may be limited to an upper limit for the voltage control (V\textcircled{1}) to cause the fuel cell 10 to maintain an output power at a predetermined value, but may not be used in the low output section, as described above.

Referring to FIG. 4, the avoidance driving of the fuel cell 10 in a low output section may be achieved by both a voltage adjustment of the bidirectional DC/DC converter 21 and adjustment of the air supply in the idle stop and restart processes according to the present invention (e.g., no voltages formed between OCV and V\textcircled{1}). Voltages V\textcircled{1} and V\textcircled{3} may be set to be about Pidle, but considering Hysteresis, V\textcircled{1} and V\textcircled{3} may be set to be voltages that correspond to Pidle_off and Pidle_on, respectively.

In the restart process, a required amount of air for the resupply of air may be calculated from a demand current of the fuel cell, and blowing a greater amount of air by a predetermined amount (α) plus the demand current allow voltage stability to be recovered more rapidly. In addition, VC), which is a voltage control value of the bidirectional DC/DC converter 21 in the EV mode drive during the idle stop of the fuel cell system may be set to be a value in consideration of the efficiency of both the bidirectional DC/DC converter 21 and the driving motor 32, etc., and a diagnostic logic relevant to cell voltage deviation, air flow, etc. may be stopped to prevent the diagnostic logic-induced shutdown of the fuel cell and vehicle during the EV mode driving.

In a restart process of the fuel cell 10, as can be seen in FIG. 4, the restart may be completed by increasing and maintaining the voltage of the bidirectional DC/DC converter 21 at a predetermined level under the condition of turning on the relay (reference numeral 14 of FIG. 1) of the fuel cell, followed by increasing the voltage of the fuel cell 10 through air supply while allowing the fuel cell 10 to output a substantially constant output power that corresponds to the maintained voltage value of the bidirectional DC/DC converter 21. Sequences on normal start may be employed. FIG. 5 is an exemplary table summarizing the detection of statuses by diagnostic level, together with causes of the statuses, used in a driving control method of a fuel cell system according to one exemplary embodiment of the present invention.

Referring to FIG. 5, a diagnostic level for oversupplied air supplied to the fuel cell stack or for water shortage status of the fuel cell stack is represented by Flt Lvl. Diagnostic levels (Lvl) are classified as three levels according to severity of water shortage based on the extent of oversupply of air or deterioration. In other words, the three diagnostic levels according to one exemplary embodiment of the present invention may be determined based on the degree of oversupply of air or water shortage. The exemplary embodiment is shown under the assumption that the three diagnostic levels are designated respective diagnostic levels of first, second and third status. A cause of the first status may be breakdown of the fuel cell system and components of the fuel cell system. A cause of the second status may be from inability to detect breakdown of the fuel cell system or components of the fuel cell system, a driving pattern, or an environmental element. A cause of the third status may be water shortage of the fuel cell due to the deterioration of the fuel cell stack.

In other words, the water shortage of the fuel cell stack may be determined based on the status of either oversupplied air or deterioration of the fuel cell stack. In this context, the first status may be a status in which air is supplied to the fuel cell stack in an amount greater than is required by the fuel cell stack (e.g., oversupply of air) due to the breakdown of the fuel cell system. In the second status, air may be oversupplied or dry-out (e.g., water shortage) may occur even though the fuel cell system is operated normally (e.g., without failure). A status in which the fuel cell stack is already undergoing deterioration may be designated as the third status. In particular, a higher diagnostic level (Flt Lvl) may indicate a more severe degree to which the deterioration of the fuel cell stack proceeds. A lower diagnostic level may indicate a system that is less prone to the occurrence of water shortage. A higher diagnostic level may require a more intensive strategy for recovery driving (e.g., increasing the number and level of recovery driving).

The first status may be a condition under which air may be supplied in an amount greater than required since a normal driving of the fuel cell system (in particular, air supplying system) may not be possible. It may also account for a condition under, even at a substantially low output, may not be possible to stop electricity generation of the fuel cell. In this context, oversupply of air may occur with a basic amount of air inflow even at the low output. The basic amount of air inflow may refer to a minimum amount of air flow supplied in the condition excluding Idle Stop, irrespective of load conditions. The first status may be determined by conditions including FC Only mode, fixed Rpm emergency driving in an emergency status of an air blower caused by breakdown of at least one of hall sensor or current sensor of the air blower, an output power shortage of the high voltage battery 20, a low temperature in the fuel cell, and the like. For example, the first status may be a status in which air is supplied in an amount greater than required as fixed Rpm driving is performed upon the emergency operation of the air blower or in which air is excessively supplied by inertia flow in a deceleration area when the regenerative braking of the air blower is not possible (e.g., excessive battery SOC, poor control of the air blower).

The second status may be a status in which the breakdown of either the fuel cell system or components of the fuel cell system such as air blower, etc. may not be detected. For example, oversupply of air may occur for reasons such as: an abnormal status of the fuel cell system may not be diagnosed, a fuel cell system is normal but a specific driving pattern like rapid acceleration/deceleration is repeated, and there is ram-air intake at downhill driving or when a draft is strong. Accordingly, to determine these conditions as the second status, the rate of the oversupply of air to current consumption, a consumed amount of current generated in the fuel cell stack may be calculated or, and an amount of water remaining in the fuel cell stack may be indirectly inferred through a humidity estimation model in the cathode.

A first method for calculating the rate of oversupply of air to current consumption may include defining a quantitative difference between supplied air and air required for current consumption as an oversupplied air amount, calculating the oversupplied air amount deviation based on an amount of oversupplied air, a reference amount of oversupplied air, and a driving temperature weighting factor, and performing a time integration of oversupplied air amount deviation. A status in which an integral value of the oversupplied air amount deviation to time is greater than a first reference value may be determined as the second status.

A second method for calculating the rate of oversupply of air to current consumption may include defining a rate of an air amount required for current consumption to a supplied air amount as an oversupplied air rate, and performing time integration of oversupplied air rate deviation based on an oversupplied air rate, a reference oversupplied air rate, and a driving temperature weighting factor. When an integral value of oversupplied air rate deviation to time is greater than a first reference value, the second status may be determined.

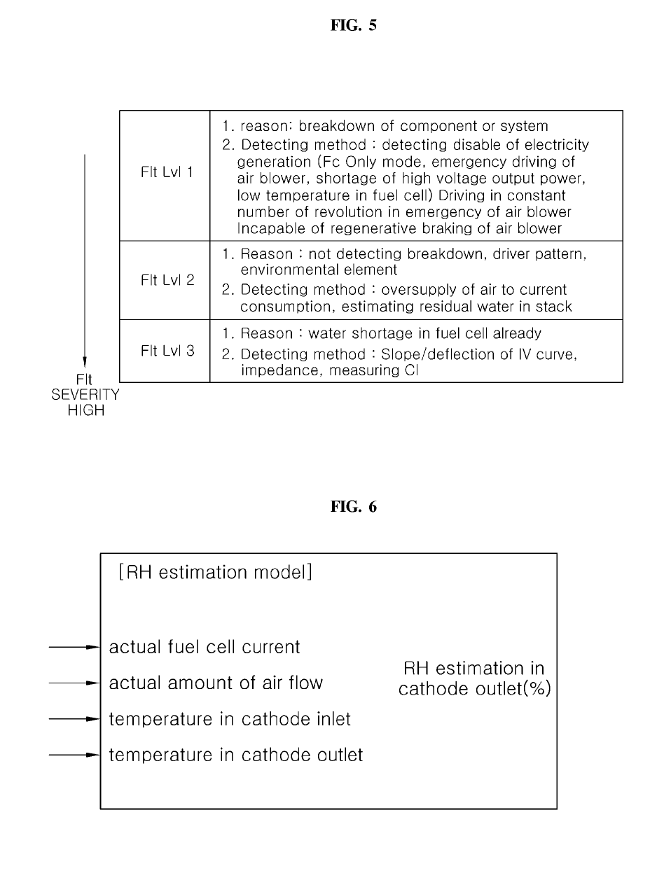

A strategy for estimating an amount of residual water of the fuel cell stack is illustrated in FIG. 6. FIG. 6 is an exemplary schematic view illustrating a relative humidity estimation model in a driving control method of a fuel cell system according to one exemplary embodiment of the present invention. Referring to FIG. 6, an RH estimation model is shown with an assumption that there are no quantitative variations of water in the cathode of the fuel cell stack. In the estimation model, an amount of water vapor that flows in an inlet of the fuel cell stack, an amount of generated water, an amount of water moved between the cathode and the anode in the fuel cell stack may be considered to estimate relative humidity in the outlet of the cathode of the fuel cell stack.

In particular, variables necessary for estimating relative humidity in the cathode may include air temperatures in both an inlet and an outlet of the cathode of the fuel cell stack, an amount of air flow in the inlet of the fuel cell stack, and an amount of generated current of the fuel cell stack A total air pressure in the inlet of the fuel cell stack may be a function of an amount of air flow in the inlet of the cathode of the fuel cell stack, and a total air pressure in the outlet of the cathode of the fuel cell stack may be a function of an amount of air flow in the inlet of the fuel cell stack Saturated water vapor pressures in the inlet and the outlet of the cathode of the fuel cell stack may be a function of air temperatures in the inlet and the outlet of the cathode of the fuel cell stack.

To estimate an amount of residual water within the fuel cell stack, an amount of water vapor flow in the outlet of the fuel cell stack may be calculated at an estimated value of the relative humidity of the outlet of the cathode. In particular, an amount of water vapor flow in the outlet of the fuel cell stack may be a product of an amount of dry air flow in the outlet of the fuel cell stack (an amount of air flow in the inlet of the fuel cell stack minus an amount of reacted oxygen) by 0.622 (mass of 1 mol water vapor divided by mass of 1 mol dry air) times a rate of a water vapor pressure in the outlet of the cathode of the fuel cell stack to a difference between a total air pressure in the outlet of the fuel cell stack and a water vapor pressure in the outlet of the cathode.

Furthermore, at a relative humidity of about 100% (e.g., a range of about 90% to about 110%) in the outlet of the cathode, an amount of water vapor flow in the outlet of the fuel cell stack may be calculated. A calculation method may be the same as for a relative humidity of an estimated value in the outlet of the cathode. An amount of residual water may be estimated by time integration of a difference between the amount of water vapor in the outlet of the fuel cell stack at a relative humidity of about 100% in the outlet of the cathode and the amount of water vapor flow in the outlet of the fuel cell stack at a relative humidity of the estimated value in the outlet of the cathode. The second status may be determined by these methods.

The third status in which water shortage occurs in the fuel cell stack may be detected by determining deterioration based on slopes and deflections of current-voltage curves, impedance measurements, membrane resistance measurements through CI (Current Interrupt Method), etc. When the fuel cell stack is determined as one of the first, the second, and the third status, they may be, respectively, designated to a first, a second, and a third diagnostic level of the multiple diagnostic levels. In other words, the fuel cell stack may be designated to one of the multiple diagnostic levels according to the determined status. For example, as illustrated in FIG. 5, the determined conditions may be categorized to three statuses that correspond to the three diagnostic levels. Water shortage or oversupply of air may be corrected based on a recovery driving mode suitable for the designated diagnostic level.

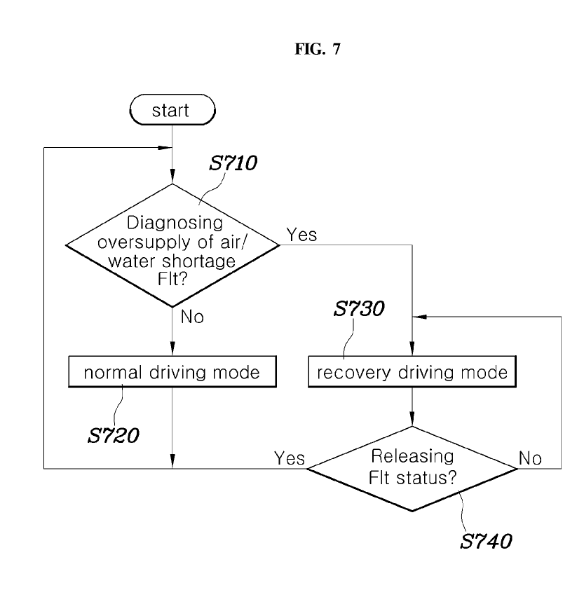

FIG. 7 is an exemplary flow diagram illustrating a driving control method of a fuel cell system according to one exemplary embodiment of the present invention. As shown in FIG. 7, to the controller may be configured to determine whether the fuel cell stack is subject to a first status, a second status, or a third status of FIG. 5 (S710), and when the status of the fuel cell stack corresponds to none of the classified diagnostic statuses, a normal driving mode may be operated (S720). When the fuel cell stack is diagnosed to have one of the diagnostic levels, a corresponding recovery driving mode may be selected and operated (S730). When the fuel cell stack is recovered from the first, the second, or the third status by a recovery driving mode (730), the status may be determined again with regard to oversupply of air or water shortage (S710). A recovery driving mode may be repeated until the fuel cell stack is recovered from the first, the second status, or the third status.

The recovery driving mode may include a recovery driving mode for forcibly cooling the fuel cell stack by adjusting temperatures in both the coolant inlet and outlet of the fuel cell stack, a recovery driving mode for relieving an Idle Stop ingress condition of the fuel cell system, a recovery driving mode for decreasing a voltage of a main bus terminal connected to an output terminal of the fuel cell stack, a recovery driving mode for reducing a basic amount of air inflow, and a recovery driving mode for driving the fuel cell stack in a minimum stoichiometry ratio (SR).

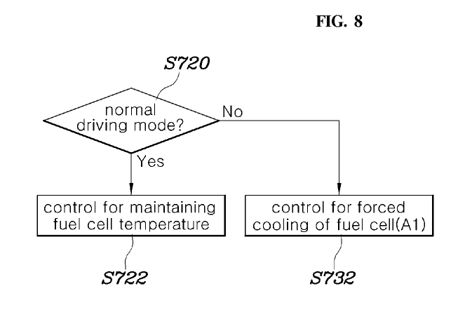

FIG. 8 is an exemplary flow diagram illustrating a driving control method of a fuel cell system according to one exemplary embodiment of the present invention. As shown in FIG. 8, the controller may be configured to determine whether the fuel cell stack operates in a normal driving mode (S720), and when the fuel cell stack operates in a normal driving mode, the temperature of the fuel cell may be maintained (S722) and when the fuel cell stack is not in a normal driving mode, a recovery driving mode may be operated to forcibly cool the fuel cell (S732). This forcible cooling operation may be executed by a cooling controller, a part of a fuel cell controller.

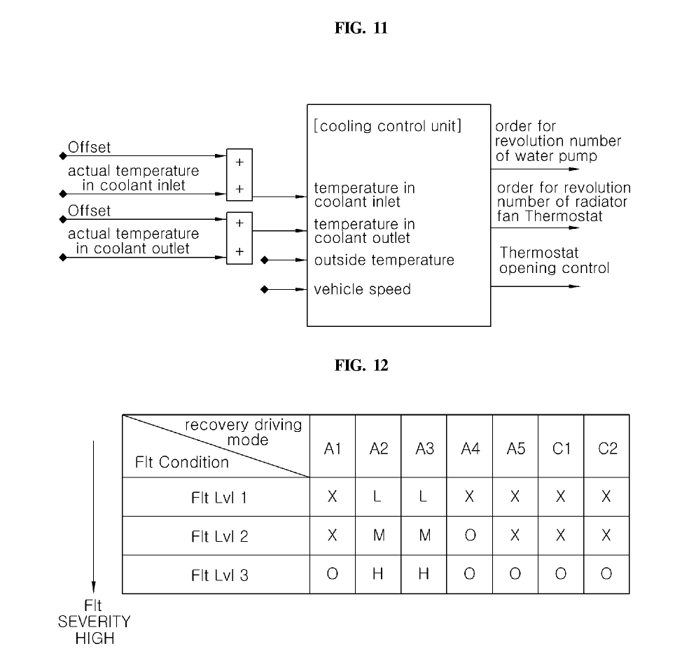

FIG. 11 is an exemplary view illustrating a forcible cooling recovery driving according to one exemplary embodiment of the present invention. As can be seen in FIG. 11, the cooling controller may be configured to receive information regarding temperatures in the coolant inlet and outlet of the fuel cell stack, exterior temperatures, vehicle speed, etc. and set target temperatures for the coolant inlet and outlet to perform forcible cooling control, a recovery driving mode. To cool the temperature to the target value, the cooling controller may be configured transmit to a water pump, a radiator fan and a thermostat information regarding the revolution numbers of the water pump and the radiator fan, and the opening control of the thermostat.

In a recovery driving mode, a relief of water shortage in the fuel cell stack may be achieved by decreasing a driving temperature of the fuel cell stack through forcible cooling. In other words, a recovery driving mode for forcibly cooling the fuel cell stack is that the fuel cell stack may be forcibly cooled by setting target temperatures in a coolant inlet and outlet to be less than a reference temperature. Hence, when receiving information regarding temperatures in the coolant inlet and outlet, the cooling controller may use as input values temperatures that are greater by offset than actual temperatures in the coolant inlet and outlet.

Target temperatures in the coolant inlet and outlet may be set to be less than required. For example, when the fuel cell stack is diagnosed to correspond to the third level, selection may be made of a recovery driving mode for forcibly cooling the fuel cell stack by adjusting temperatures in the coolant inlet and outlet of. In other words, a recovery driving mode for forcibly cooling the fuel cell stack by setting target temperatures in the coolant inlet and outlet to be less than conventionally set temperatures may be used (A1 in FIG. 12).

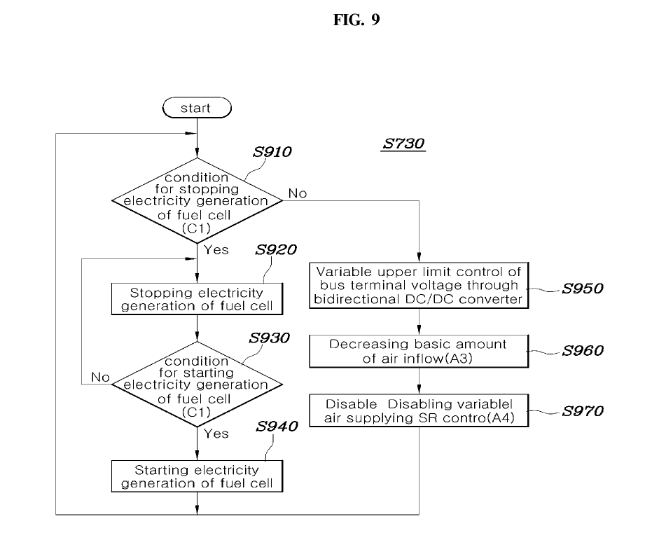

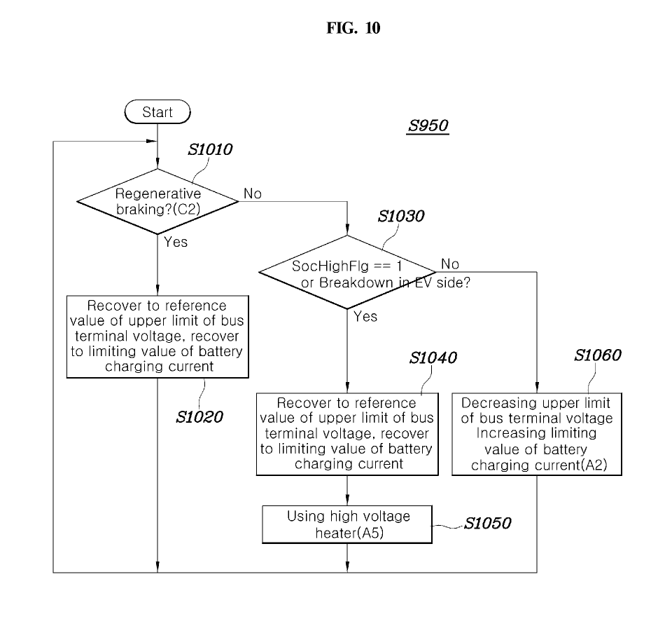

FIGS. 9 and 10 are exemplary flow diagrams illustrating driving control methods of a fuel cell system according to one exemplary embodiment of the present invention, and FIG. 12 is an exemplary table illustrating recovery driving modes corresponding to status of a fuel cell stack according to one exemplary embodiment of the present invention. FIG. 9 describes controlling electricity generation and Idle Stop in the fuel cell through a recovery driving mode.

As described above with regard to FIG. 2, the fuel cell may be operated to generate electricity or stop electricity generation based on loads on the vehicle, a state of charge of battery (SOC), a status of the fuel cell, etc. In a recovery driving mode, however, a condition for stopping electricity generation of the fuel cell may be relieved to extend an electricity generation-stopping area of the fuel cell. The electricity generation stopping area of the fuel cell may be extended, for example, by increasing reference values for Pidle_off, and Pidle_on, reducing criteria for SOC_{high} and SOC_{low}, or deleting some of fuel cell status check items.

By way of example, as illustrated in FIG. 12, when the fuel cell stack is subject to the third status that corresponds to the third diagnostic level, the electricity generation-stopping area of the fuel cell may be extended. In other words, the condition for ingress into Idle Stop may be relieved. In this regard, to the controller may be configured to determine whether the status of the fuel cell stack satisfies a condition for stopping electricity generation (S910), and if so, the fuel cell may be operated to stop electricity generation (S920). After that the fuel cell stack is diagnosed to determine a status suitable for restarting (S930), the fuel cell may be operated to be restarted (S940). Further, when the diagnostic level is not a condition for stopping electricity generation of fuel cell, various recovery driving modes may be operated. First, the upper voltage limit of the bus terminal may be variably adjusted through the bidirectional DC/DC converter 21 (S950).

FIG. 10 is an exemplary flow diagram illustrating a method of variably adjusting an upper voltage limit of a main bus terminal according to one exemplary embodiment of the present invention. The method of variably adjusting an upper voltage limit of a main bus terminal using a bidirectional DC/DC converter may include determining when the driving motor 32 is currently operating regenerative braking (S1010). When the driving motor 32 is operating regenerative braking, an upper voltage limit of the main bus terminal may be reverted to about the voltage of the open circuit (S1020) since when the upper voltage limit of the main bus terminal is decreased during regenerative braking, the current for charging the high voltage battery 20 reduces the regenerative braking, incurring a loss of fuel efficiency. Even in a recovery driving mode, therefore, the fuel cell controller may be configured to determine whether regenerative braking is operated, and if so, may not perform a downward driving for decreasing the upper voltage limit of the main bus terminal to avoid a loss of fuel efficiency.

However, as illustrated in FIG. 12, when the fuel cell stack is subject to the third diagnostic level that corresponds to the third status, the high voltage battery may be charged by decreasing an upper voltage limit of the main bus terminal regardless of regenerative braking since recovery of the fuel cell from water shortage is more important despite loss in fuel-efficiency (C2 in FIG. 12). Thus, determining when the driving motor 32 is operating regenerative braking may be omitted.

To operate a recovery driving mode for decreasing an upper voltage limit of the main bus terminal, the fuel cell controller may be configured to determine the state of charge (SOC) of a high voltage battery and whether breakdown exists in the EV (S1030). In other words, the fuel cell controller may be configured to determine whether charging of a high voltage battery is possible, and decrease an upper voltage limit of the main bus terminal when charging of the high voltage battery is possible (S1060). In case of decreasing the upper voltage limit, when the fuel cell stack is diagnosed to be subject to a higher level, the upper voltage limit of the main bus terminal may be decreased further (A2 in FIG. 12).

When the high voltage battery is fully charged or breakdown is present in the EV, the upper voltage limit of the main bus terminal may not be decreased and the fuel cell stack may be driven at the upper limit of the normal driving mode (S1040). For example, when the state of charge (SOC) of the battery is greater than a predetermined SOC, in other words, when the battery is fully charged, a high voltage heater connected to an output terminal of the fuel cell stack may be operated, instead of the operation of the recovery driving mode for decreasing the voltage of the main bus terminal connected to an output terminal of the fuel cell stack.

Additionally, when the fuel cell stack is in an extreme condition such as oversupply of air or water shortage, when the diagnosed level is a third status, the high voltage heater connected to the fuel cell may be used to generate water in the fuel cell (S1050, A5 in FIG. 12). In other words, when the fuel cell stack is in the third diagnostic level, selection may be made of a recovery driving mode in which the output of the fuel cell stack is operated based on loads to perform a load following drive. Breakdown of the EV side may be caused from the bidirectional DC/DC converter or the high voltage battery, and the high voltage heater may not be used. A decrease of the upper voltage limit of the main bus terminal may decrease the frequency of low power use and increase electricity generation-stopping area and the frequency of generation of the base current in the fuel cell. Additionally, the area of use of the high voltage battery may be extended.

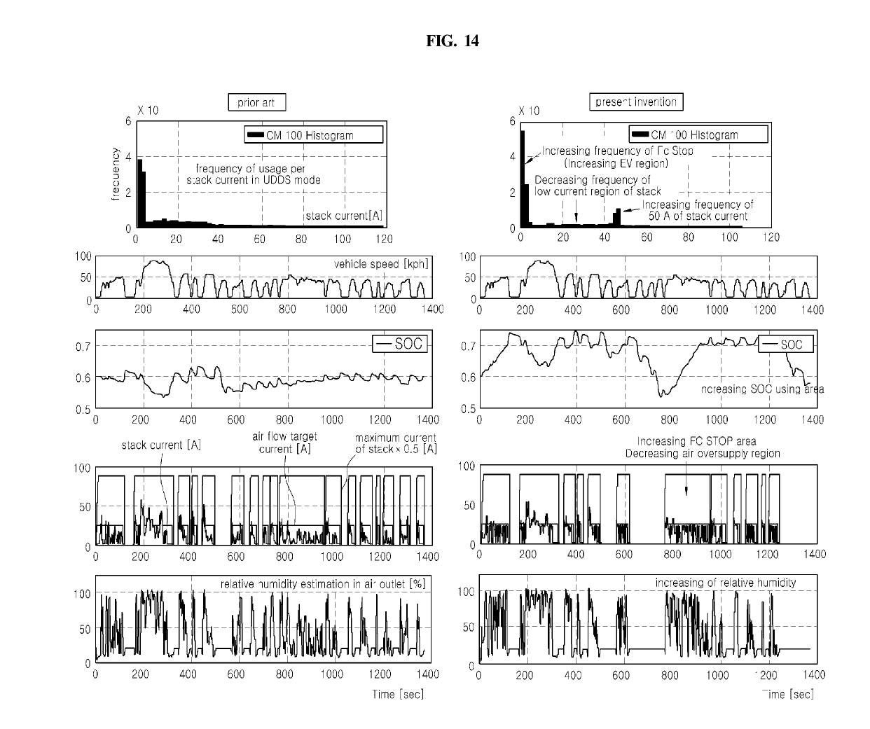

These effects are shown in graphs of FIG. 14 that illustrate comparisons between the present invention and conventional methods with regard to vehicle speed, battery state, relative humidity, etc. As compared to conventional techniques, the fuel cell stack of the present invention decreases frequency of low power use and increases in electricity generation-stopping area, and frequency of generation of base current. As is understood from the graph regarding the state of charge of battery, the area of use of the high voltage battery, that is, the charge and discharge area is extended. In other words, when the fuel cell stack requires a substantially low current, an excess of power may be forcibly charged to the battery, thus extending the driving range to the EV mode.

After decreasing the upper voltage limit of the main bus terminal using the bidirectional DC/DC converter 21, the fuel cell controller may be configured to decrease a basic amount of air inflow (S960). For example, the fuel cell controller may be configured to decrease the basic amount of air inflow from an amount of air flow that corresponds to a current of 30 A to an amount of air flow to a current of 10 A. In the decrease of the basic amount of air inflow according to whether the fuel cell stack is subject to the first, the second, or the third status, the air amount supplied to the fuel cell stack may be reduced further at a higher diagnostic level (A3 in FIG. 12). In other words, when the fuel cell stack operates in a recovery driving mode for decreasing a basic amount of air inflow, the stoichiometry ratio controlling area may be variably decreased based on a designated diagnostic level. Additionally, the variable SR control may be disabled to drive at a minimum SR, thereby minimizing the air supply (S970, A4 in FIG. 12). For example, when the fuel cell stack is subject to the second or the third diagnostic level, selection may be made of a recovery driving mode for driving the fuel cell stack in a minimum SR.

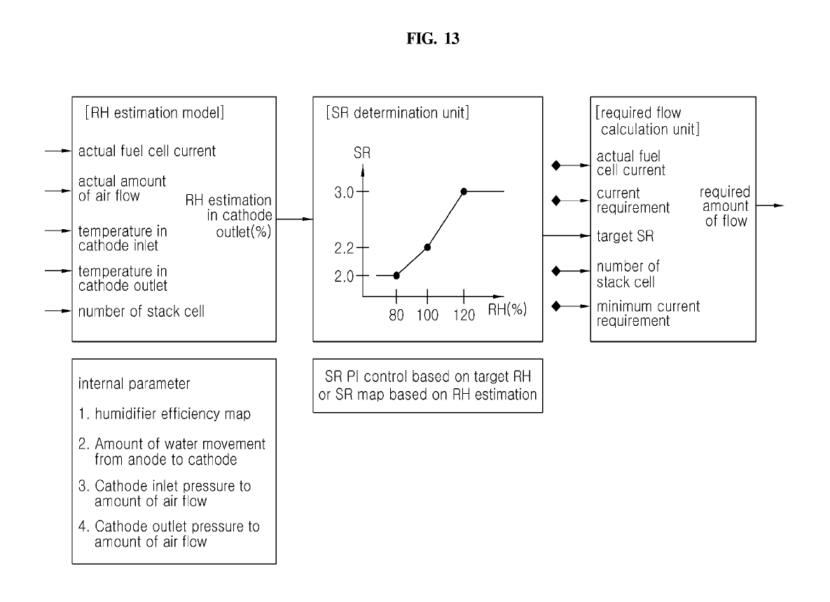

FIG. 13 is an exemplary view schematically illustrating variable stoichiometry ratio control on air supply according to one exemplary embodiment of the present invention. As illustrated in FIG. 13, a relative humidity (RH) estimation model receives an actual fuel cell current, an actual air flow amount, a temperature of a cathode inlet, a temperature of a cathode outlet, and the number of fuel cells in a fuel cell stack as inputs, and has internal parameters including a humidifier efficiency map, an amount of water movement from the anode to the cathode, an air pressure in a cathode inlet against to the air flow amount, an air pressure in a cathode outlet against the air flow amount. In the RH estimation model, a target stoichiometry ratio may be determined using a stoichiometry ratio map in which estimated values of relative humidity in the cathode outlet or through stoichiometry ratio PI control on target relative humidity. As illustrated, the stoichiometry ratio may be variably adjusted based on estimated values of relative humidity. However, this variable control may be disabled and the fuel cell stack may be operated in a recovery driving mode intended to drive in a minimum stoichiometry ratio.

For example, a recovery driving mode in which the fuel cell stack is operated at a minimum stoichiometry ratio (SR) includes decreases a control area of stoichiometry ratio according to the relative humidity in the cathode of the fuel cell stack estimated from temperatures in the cathode inlet and outlet of the fuel cell stack, the amount of air flow in the inlet of the fuel cell stack, and the generated current of the fuel cell stack. When the fuel cell stack operates in a recovery driving mode at a minimum SR, the stoichiometry ratio controlling area may be variably decreased based on a designated diagnostic level. In a recovery driving mode, the electricity generation-stopping area of the fuel cell may be extended, and water may be generated by decreasing air supply and generating an output power of the fuel cell simultaneously although electricity generation is not stopped. In spite of the likelihood of a loss in drive ability and fuel efficiency, low power operation may be avoided to prevent the fuel cell from being deteriorated by water shortage.

As described above, the recovery driving modes may be conducted at lower intensity, with a lower number of the items, either for lower diagnostic levels or when the fuel cell stack is diagnosed to exhibit a lower degree of oversupply of air or water shortage. Representative among the recovery driving modes is a recovery driving mode for forcibly cooling the fuel cell stack by adjusting temperatures in the coolant inlet and outlet of the fuel cell stack, a recovery driving mode for relieving conditions of ingress into Idle Stop of the fuel cell system, a recovery driving mode for decreasing a voltage of the main bus terminal connected to output terminal of the fuel cell stack, a recovery driving mode for driving the fuel cell stack at a minimum SR, and a recovery driving mode for reducing an air amount supplied to the fuel cell stack. However, the recovery driving modes should be selectively taken according to the status of the fuel cell stack due to a loss of either fuel efficiency or acceleration responsiveness.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A driving control method of a fuel cell system, comprising:
determining, by a controller, when a fuel cell stack is in a water shortage, based on an oversupply of air to the fuel cell stack or a deterioration of the fuel cell stack;
assigning, by the controller, a diagnostic level to the fuel cell system based on the determination; and
performing, by the controller, at least one recovery driving mode that corresponds to the assigned diagnostic level.

2. The method of claim 1, wherein the assigning process includes:
classifying, by the controller, a first status as a first diagnostic level, the first status being a status under which the oversupply of air to the fuel cell stack is predicted due to a breakdown of the fuel cell system.

3. The method of claim 1, wherein the assigning process includes:
classifying, by the controller, a second status as a second diagnostic level, the second status being a status under which the fuel cell stack is predicted to be in the water shortage due to the oversupply of air to the fuel cell stack.

4. The method of claim 3, wherein the second status is determined based on either a change in oversupply of air to the fuel cell stack to output current consumption of the fuel cell stack or a change of residual water in a cathode calculated from an estimated value of relative humidity in the cathode of the fuel cell stack.

5. The method of claim 3, wherein the second status is a status in which a value calculated from oversupply of air, which is a difference between an amount of air required for output current consumption of the fuel cell stack and an amount of air supplied to the fuel cell stack, and a driving temperature of the fuel cell stack is greater than a first reference value.

6. The method of claim 3, wherein the second status is a status in which a value calculated from a ratio of an amount of air supplied to the fuel cell stack to an amount of air required for output current consumption of the fuel cell stack, and a driving temperature of the fuel cell stack is greater than a first reference value.

7. The method of claim 4, wherein the estimated value of relative humidity in the cathode of the fuel cell stack is obtained based on temperatures in cathode inlet and outlet of the fuel cell stack, an amount of air flow in an inlet of the fuel cell stack, and an amount of current generated in the fuel cell stack.

8. The method of claim 4, wherein the change of residual water is calculated based on water vapor flow in the cathode outlet when the relative humidity in the cathode outlet is the estimated value and when the relative humidity in the cathode outlet is in a range of about 90% to 110%.

9. The method of claim 8, wherein the amount of water vapor flow in the cathode outlet is calculated by water vapor pressure in the cathode outlet, air pressure in the cathode outlet based on an amount of air flow in an inlet of the fuel cell stack, and an amount of air flow in the inlet of the fuel cell stack.

10. The method of claim 1, wherein the assigning process includes:
assigning, by the controller, a third diagnostic level to the fuel cell system when deterioration of the fuel cell stack has proceeded to a third status due to water shortage, as diagnosed with regard to current and voltage, impedance or current interruption of the fuel cell in the determination process.

11. The method of claim 1, wherein the recovery driving mode includes a recovery driving mode for forcibly cooling the fuel cell stack by adjusting temperatures in coolant inlet and outlet of the fuel cell stack, a recovery driving mode for relieving a condition of ingress into idle stop of the fuel cell system, a recovery driving mode for decreasing a voltage of a main bus terminal connected to an output terminal of the fuel cell stack, a recovery driving mode for reducing a basic amount of air inflow, and a recovery driving mode for driving the fuel cell stack in a minimum stoichiometry ratio (SR).

12. The method of claim 11, wherein the recovery driving mode for forcibly cooling the fuel cell stack is operated by setting target temperatures in the coolant inlet and outlet to be a lower value than a reference temperature.

13. The method of claim 11, wherein the recovery driving mode for forcibly cooling the fuel cell stack is operated as temperatures in the coolant inlet and outlet are set to be greater by a predetermined offset than an actual temperature.

14. The method of claim 12, wherein the recovery driving process is operated by varying the set reference temperature and the offset according to the assigned diagnostic level.

15. The method of claim 11, wherein
the condition for ingress into idle stop is when a fuel cell vehicle is imparted with a load less than a predetermined reference value and has a state of charge (SOC) of a battery greater than a predetermined state of charge; and
the recovery driving mode for relieving a condition for ingress into Idle Stop is to increase the predetermined reference value and to decrease the predetermined state of charge.

16. The method of claim 15, wherein the fuel cell stack is operated in a recovery driving mode in which the predetermined reference value is increased and the predetermined state of charge is decreased based on the designated diagnostic level.

17. The method of claim 11, wherein when the fuel cell stack is operated in the recovery driving mode for decreasing a voltage of the main bus terminal connected to an output terminal of the fuel cell stack, further includes:
determining, by the controller, whether charging of the battery is possible before proceeding with the recovery driving, and
wherein the fuel cell stack in the recovery driving mode for decreasing a voltage of the main bus terminal is to decrease an upper limit of a driving voltage of the main bus terminal to prevent an output power of the fuel cell stack from being less than a predetermined output power.

18. The method of claim 11, wherein the fuel cell stack is operated in the recovery driving mode for decreasing a voltage of the main bus terminal connected to the output terminal of the fuel cell stack based on the designated diagnostic level, even during regenerative braking

19. The method of claim 17, wherein when a state of charge (SOC) of the battery is greater than a predetermined SOC in the process of determining whether charging of the battery is possible before performing the recovery driving, the fuel cell stack is operated to drive a high voltage heater connected to the output terminal of the fuel cell stack.

20. The method of claim 11, wherein when the fuel cell stack is operated in recovery driving mode for decreasing a voltage of the main bus terminal connected to the output terminal of the fuel cell stack, an upper voltage limit of the main bus terminal connected to the output terminal of the fuel cell stack is decreased based on the designated diagnostic level.

21. The method of claim 11, wherein when the fuel cell stack is operated in a recovery driving mode for reducing a basic amount of air inflow, the basic amount of air inflow is decreased based on the designated diagnostic level.

22. The method of claim 11, wherein the recovery driving mode intended to drive the fuel cell stack in a minimum stoichiometry ratio (SR) includes decreasing a control area of stoichiometry ratio based on relative humidity in the cathode of the fuel cell stack estimated from temperatures in the cathode inlet and outlet of the fuel cell stack, the amount of air flow in the inlet of the fuel cell stack, and the generated current of the fuel cell stack.

23. The method of claim 22, wherein when the fuel cell stack is operated in a recovery driving mode at the minimum stoichiometry ratio (SR), the stoichiometry ratio controlling area is decreased based on a designated diagnostic level.

24. The method of claim 1, wherein the fuel cell stack is operated in one mode selected from among various driving modes based on the designated diagnostic level.

25. A driving control system of a fuel cell system, comprising:
a memory configured to store program instructions; and
a processor configured to execute the program instructions, the program instructions when executed configured to:
determine when a fuel cell stack is in a water shortage, based on an oversupply of air to the fuel cell stack or a deterioration of the fuel cell stack;
assign a diagnostic level to the fuel cell system based on the determination; and
perform at least one recovery driving mode that corresponds to the assigned diagnostic level.
